(19) United States
(12) Patent Application Publication
(10) Pub. No.: US 2008/0236533 A1
(43) Pub. Date: Oct. 2, 2008

(54) Device for closing a separation area of an air intake duct of an internal combustion engine

(76) Inventor: Stefanie Schwingenschlogl, Filderstadt (DE)

Correspondence Address: KLAUS J. BACH, 4407 TWIN OAKS DRIVE, MURRYSVILLE, PA, 15668, US

(21) Appl. No.: 12/069,434

(22) Filed: Feb. 8, 2008

Related U.S. Application Data
(63) Continuation-in-part of application No. PCT/EP2006/006942, filed on Jul. 15, 2006.

(30) Foreign Application Priority Data
Aug. 10, 2005 (DE) 10 2005 037 720.3

(51) Int. Cl. F02M 35/104

(52) U.S. Cl. 123/184.21

(57) ABSTRACT

In a device for mechanically closing a separation point between an air intake duct associated with a drivers cap and a connecting duct associated with a chassis supporting an internal combustion engine of a motor vehicle, wherein a locking mechanism is provided which is operable by a tilting of the driver's cab about the driver's cab pivot axis into, or out of, its drive position, the locking mechanism comprises a first locking element supported on the driver's cab and a second locking element associated with an air filter mounted on the chassis and at least one of the locking elements comprises a control cam, which can be moved into engagement with the other locking element by a pivoting of the driver's cab into its drive position.

This is a Continuation-In-Part application of pending international patent application PCT/EP2006/006942 filed Jul. 15, 2006 and claiming the priority of German patent application 10 2005 037 720.3 filed Aug. 10, 2005.

### BACKGROUND OF THE INVENTION

The invention relates to a device for mechanically closing a separation area of an air intake duct of an internal combustion engine of a motor vehicle, especially a commercial vehicle, such as a truck, comprising a vehicle chassis and a driver's cab that can be tilted in relation to the chassis of the vehicle about a driver's cab pivot axis. The device is arranged between an air inlet duct fixed to the driver's cab and carried thereby and a connecting duct including an air filter, which is detachably connectable to the inlet duct and is fixed to the vehicle chassis by which it is also supported. The device is closed when the driver's cab is in a normal position or drive position and open when the driver's cab, together with the air inlet duct, is pivoted into a tilted position, that is, preferably tilted forwardly about the driver's cab pivot axis. At the separation point the duct sections are mechanically lockable directly by means of a locking mechanism, or they are lockable indirectly by the tilting of the driver's cab about the driver's cab pivot axis into its normal or drive position.

Such a device is disclosed by EP 0 342 543 A1. A device is proposed there, which when the driver's cab is tilted back into its normal position is intended to improve the guidance and alignment of an elastic corrugated hose, arranged at the free end of a snorkel-shaped air inlet duct at a separation point of an intake duct, relative to an air filter connection, and to achieve a good sealing at the separation area even during the relative movements between the driver's cab and the vehicle chassis that occur in operation of the motor vehicle.

For the latter purpose, compression springs acting on a connecting flange defining the separation point and arranged at the lower end of the corrugated hose are provided, which exert a spring force acting in a direction away from the air inlet duct on the connecting flange. The spring travel is limited on both sides, that is to say upwards and downwards in this case, by pins carried in elongated holes. With the driver's cab in the drive position, therefore, the spring force of the springs constantly acts on the connecting flange of the intake duct, so that under the spring force said flange is pressed on the connecting seat of the air filter connection.

With this design, however, unwanted opening of the separation point can nevertheless occur under especially harsh operating conditions, allowing foreign matter, such as water, dirt, ice, snow and the like to get into the air filter and hence into the air intake system, something that must be avoided at all costs.

U.S. Pat. No. 4,378,945 discloses a similarly functioning design. Here, in contrast to the device previously described, a contact pressure of the connection seat against a connecting flange of an intake line firmly connected to the driver's cab can be achieved by the spring force of springs acting on a moveable engagement seat of an air filter, when the driver's cab is pivoted into its drive position, in which the separation area is to be closed. The aforementioned disadvantages however can also occur with this design.

DE 195 48 340 C1 discloses an intake air line for an internal combustion engine which comprises two pipes. The pipes are connected to one another by a corrugated hose, the two ends of the corrugated hose being clamped air-tightly onto the pipes by clamps secured by bolted connections. One of the pipes is connected to an internal combustion engine and the other pipe is connected to an air intercooler. Fixed to each of the two clamps are hooks, in which rubber rings are supported, tensioned between the two clamps, so that the corrugated intake air line is guided and supported in the area between the clamps. The clamps are firmly clamped to the respective ends of the pipes by means of bolted connections so that it is not possible to open the separation point without releasing the bolted connections. Such a connection is therefore unusable for the application according to the invention.

Providing a stiff, circumferential lip on the connecting pipe of an air filter, which serves for snap connection of the free end of a corrugated hose of an air intake line, when the driver's cab is pivoted into its drive position, is also commonly known. Quite apart from the fact that a force placing a stress of undefined magnitude on the corrugated hose is required in order to release this connection, this connection always has to be manually checked in each case, in order to detect and rectify any misalignment of the pipes to be joined at the separation point, in order to prevent a leak that might otherwise occur in the intake line in the area of the separation point.

It is the object of the present invention to provide an intake air duct arrangement with a separation area which overcomes the disadvantages described above and provides for a high level of security against unwanted opening of the separation area in the intake air duct to an internal combustion engine between an air inlet line and an air filter connected to inlet side of the internal combustion engine.

### SUMMARY OF THE INVENTION

In a device for mechanically closing a separation point between an air intake duct associated with a drivers cap and a connecting duct associated with a chassis supporting an internal combustion engine of a motor vehicle, wherein a locking mechanism is provided which is operable by a tilting of the driver's cab about the driver's cab pivot axis into, or out of, its drive position, the locking mechanism comprises a first locking element supported on the driver's cab and a second locking element associated with an air filter mounted on the chassis and at least one of the locking elements comprises a control cam, which can be moved into engagement with the other locking element by a pivoting of the driver's cab into its drive position.

Further features, advantages and aspects of the invention will become apparent from the following description of a preferred exemplary embodiment of the invention with reference to the accompanying drawings:

### BRIEF DESCRIPTION OF THE DRAWINGS

FIG. 1 is a partial side view of a vehicle with a pivotable driver's cab, which is shown in its drive position, substantial parts of the device according to the invention being omitted here for representational reasons but shown in FIGS. 3 and 4;

FIG. 2 is a partial side view of the vehicle according to FIG. 1, with the driver's cab pivoted forwardly about the driver's cab pivot axis into a tilted position;

FIG. 3 shows schematically a device for closing the intake air duct according to the invention; and

FIG. 4 is an enlarged, three-dimensional view of locking elements according to the invention.

### DESCRIPTION OF A PARTICULAR EMBODIMENT

The device 20 serves for mechanically closing a separation point 23 of an intake air duct 46 of an internal combustion engine (not shown) of a vehicle 38, especially a commercial vehicle, such as a truck, comprising a vehicle chassis 45 or a vehicle frame and a driver's cab 37 that can be pivoted in relation to the chassis about a driver's cab pivot axis 39. The separation point 23 is arranged between an air inlet duct 52, fixed to the driver's cab 37 and supported thereby and a connecting duct 21 of an air filter 28 or a filter housing 29. The air filter housing is detachably connected to the inlet duct 52 and is fixed to the vehicle chassis 45. It is closed when the driver's cab 37 is in its normal drive position 47. The separation point 23, as can be seen from FIG. 2, is opened when the driver's cab 37 together with the air inlet line 52 is in a tilted position 48 preferably pivoted forwardly about the driver's cab pivot axis 39, which is preferably arranged approximately perpendicular to the longitudinal axis of the vehicle 37.

With the device 20 according to the invention, at the separation point 23, the intake air duct sections are mechanically lockable directly by means of a locking mechanism 50, or indirectly by the pivoting of the driver's cab 37 about the driver's cab pivot axis 39 into its drive position 47.

According to the invention the locking mechanism 50 comprises a first locking element 51 and a second locking element 53, of which one locking element 53 is fixed to the air inlet duct 52 which is pivotable together with the driver's cab 37 about the driver's cab pivot axis 39. Another locking element 51 is connected to the vehicle chassis 45, preferably to the air filter 28, or is fixed to the connecting duct 21 which is firmly connected to said air filter. At least one locking element 51 comprises a control cam 55, which can be placed in contact with the other locking element 53 by the pivoting of the driver's cab 37 about the driver's cab pivot axis 39 into its drive position 47, so as to clamp the air inlet duct 52 firmly to the connecting duct 21, thereby closing the separation point 23. Any unwanted or spontaneous opening of the separation point 23 due, for example, to vibrations or shaking of the driver's cab 37 relative to the vehicle chassis 45, is thereby reliably prevented. Relative movements at the separation point 23, that is in the area where the air inlet duct 52 bears on the connecting duct 21, are also prevented. In this way, therefore, any unwanted entrance of foreign matter, such as dirt, water, ice, snow and the like into the air duct system, is reliably prevented. The separation point 23 therefore always remains reliably closed even if the cab 37 is spring supported and resiliently moves relative to the vehicle chassis 45 of the vehicle 38.

The device 20 according to the invention not only achieves a virtually automatic locking of the separation point 23 when the driver's cab 37 is pivoted back from a tilted position 48 into its drive position 47, but also allows for manual locking, where desired.

The control cam 55 of the locking element(s) 51 may advantageously be configured such that its outer circumference follows a smooth, continuous or closed line 56 (FIG. 4).

An especially simple and secure locking can be achieved in that at least one of the locking elements 51 is capable of pivoting about a locking element pivot axis 57 different from the driver's cab pivot axis 39, in order to bring about a locking of the separation point 23.

It is particularly advantageous if the locking element 53 carried by the air inlet line 52 is firmly, preferably rigidly, connected to the air inlet line 52 and if the locking element 51 assigned to the vehicle chassis 45 is capable of pivoting about a locking element pivot axis 57.

It may also be advantageous if only the locking element 51 assigned to the vehicle chassis 45 comprises a control cam 55.

According to a preferred exemplary embodiment, the locking element 51 assigned to the vehicle chassis 45 may be configured with a bolt or hook 58 comprising the control cam 55. The locking element 53 is fixed to the air inlet line 52 and advantageously is in the form of a cylindrical pin 59, which the hook 58, upon pivoting about its pivot axis 60, engages for the purpose of interlocking the ducts at the separation point 23.

An especially effective and easily lockable and releasable clamp-locking can be achieved in that the control cam 55 of the hook 58 arranged on the side 61 of the hook 58 facing towards the hook pivot axis 60 has a clearance 63 from the hook pivot axis 60 which preferably increases slightly in the direction of its free end 62. Such a lever contour can also advantageously compensate for positional or manufacturing tolerances.

At least two locking elements 53 are advantageously fixed to the air inlet line 52, each of which elements can be brought into operative connection with a locking element 51 assigned to the vehicle chassis 45, in order to bring about a locking of the separation point 23. A uniform locking and sealing can thereby be achieved over the periphery of the separation opening 22. For this purpose, the locking elements 51 and the locking elements 53 are advantageously arranged diametrically opposite one another.

It is particularly advantageous if at least one of the locking elements 51 can be displaced relative to another locking element 53 by means of a mechanical actuating fixture 64, fixed to the driver's cab 37 and carried thereby, in order to bring about a locking of the separation point 23.

According to a preferred exemplary embodiment, the locking element 51, capable of pivoting about a locking element pivot axis 57, may be configured as a lever 65 having lever arms 66, 67 preferably extending in different directions away from one another on both sides of the locking element pivot axis 57. The one lever arm 66 is subjected or susceptible to a force 68, which is exerted by the actuating fixture 64 when the driver's cab 37 tips into its drive position 47 and which causes the lever 65 to pivot about the locking element pivot axis 57, so that the other lever arm 67 engages the other locking element 53, in order to bring about a locking of the separation point 23. Such a lever arrangement is capable of achieving an especially high closing force.

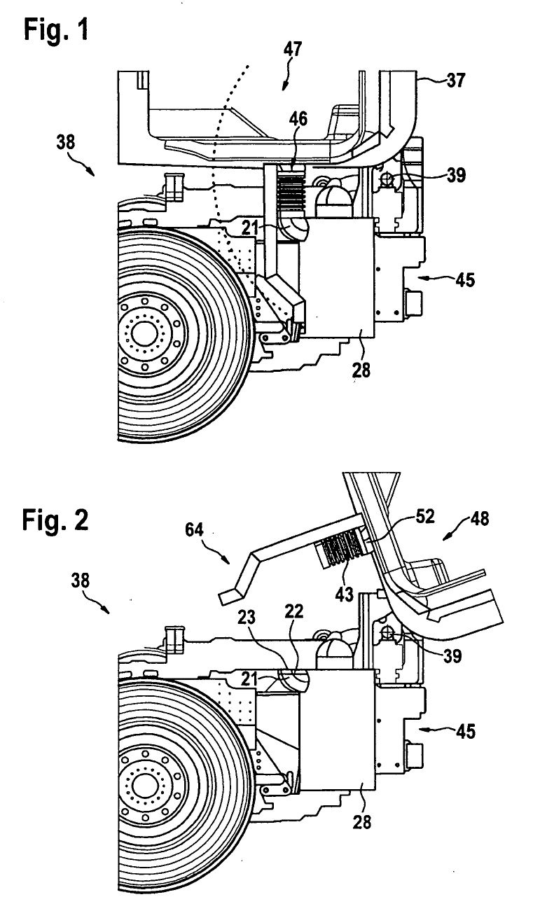

A rigid guide rail fixed to the driver's cab 37 or a rigid deflector plate, for example, may be used as actuating fixture 64. In this case a rotatable body, such as a roller or a ball, which exerts the actuating force 68 on one of the locking elements 51 for the purpose of moving that locking element 51 relative the other locking element 53 when the driver's cab 37 is pivoted into its drive position 47, may advantageously be supported on the actuating fixture 64. Such a rotatable body will also reduce the wear between the actuating fixture 64 and the locking element 51 assigned thereto, which can occur particularly as a result of relative movements caused by a movement of the driver's cab 37 relative to the vehicle chassis 45, especially since the actuating fixture 64 constantly exerts a force 68 on the locking element 51, in order to keep the separation point 23 closed when the driver's cab 37 is in the drive position 48 shown in FIG. 1.

It is furthermore advantageous if the locking elements 51, 53 assigned to the air inlet duct 52 and/or those assigned to the vehicle chassis 45 are subjected in their locking position, in which the separation point 23 is locked, to a spring force of a spring 70, which when the driver's cab 37 is pivoted from its drive position 47 into a tilted position 48 unlocks the locking elements 51, 53 or releases the clamp connection between the locking elements 51, 53, so that the separation point 23 is opened and the air inlet duct 52 can be pivoted away from the connecting duct 21. When the driver's cab 37 is pivoted from its drive position 47 into a tilted position 48, therefore, the separation point 23 can open or be opened due to the withdrawal of the force 68, and the restoring action of the springs 70, embodied as helical coil springs, for example, acting in a direction opposed to the arrow 44.

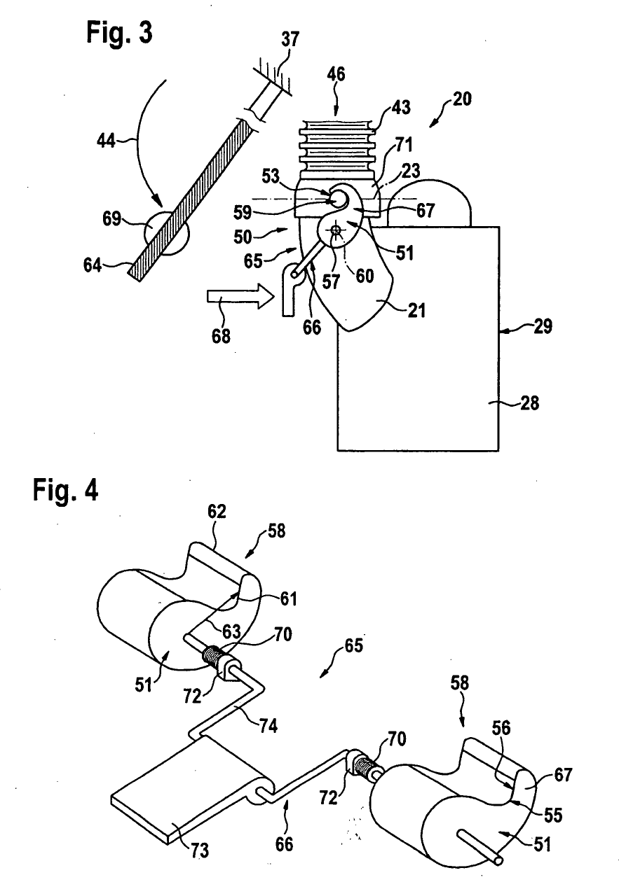

As can be seen from FIGS. 3 and 4, a first locking element 51, which is configured with a hook-shaped bolt or hook 58, is supported by way of a hook pivot axis 60, also referred to as a locking element pivot axis 57, on the connecting duct 21 of the air filter 28, that is to say in proximity to the separation point 23 indicated schematically by broken lines in FIG. 3, so that it can pivot about the hook pivot axis 60. This locking element 51 is configured as a lever 65 having the lever arms 66 and 67 extending in different directions on both sides of the hook pivot axis 60. The lever arm 67 is configured with the hook part of the hook 58, which is rotationally fixed on a T or bow-shaped shaft 74, the shaft 74 being firmly connected by way of the bearing 72 in a manner not shown further to the connecting duct 21 of the air filter 28.

The shaft 74 comprises a central area, from which two shaft parts are angled or bent towards the same side in a U-shape, a shaft part in turn being angled or bent from each of these, the two latter shaft parts extending in opposite directions and forming the actual bearing shaft for the hook 58 fixed on each of these shaft parts.

Represented schematically in the area of the bearing 72 are two springs 70, which are embodied as helical coil springs. In the closed position of locking mechanism 50 shown in FIG. 3, that is to say with the separation point 23 locked, the coil springs 70 generate a restoring force acting counter to the force 68 or a restoring moment about the hook pivot axis 60 acting in the direction opposed to the arrow 44. As a result, when the driver's cab 37 is pivoted from its drive position 47 into a tilted position 48, and the actuating fixture 64 represented schematically in FIG. 3 is simultaneously pivoted together with the driver's cab 37, the restoring forces of the springs 70 will cause the hooks 58, to pivot about their hook pivot axis 60 in the direction opposed to the arrow 64 so as to release the pins 59 which are firmly connected to a connection bell of a corrugated hose 43, in order to permit opening of the separation point 23. This allows the air inlet duct 52 with the corrugated hose 43 affixed to its end to be lifted off the connecting duct 21 of the air filter 28.

Rotationally fixed in said central area of the rigid shaft 74 as shown in the exemplary embodiment is an actuating plate 73, which is abutted by the actuating fixture 64 with the actuating force 68. In order to reduce any wear occurring between the actuating fixture 64 and the plate 73, a rotatable body 69, such as a ball or a roller, for example, is supported on the actuating fixture 64. The rotatable body 69 abuts the plate 73 with the actuating force 68 when the driver's cab 37 is pivoted from its tilted position 48 into its drive position 47 and also continues to bias the plate 73 when the driver's cab 37 is in its drive position 47. When the driver's cab 37 is pivoted from a tilted position 48 into its drive position 47, the actuating fixture 64 presses on the plate 73 via the rotatable body 69, so that as the driver's cab 37 pivots back further about the driver's cab pivot axis 39 in the direction of the arrow 44, the lever 65 with the hook 68 pivots about the hook pivot axis 60 in a direction corresponding to the direction of the arrow 44, that is in this case, counterclockwise. As a result, the free end 62 of the respective hook 58 moves over the pin 59, until the side 61 of the respective hook 58 remote from the hook pivot axis 60, which forms an eccentric control cam 55, bears on the respective pin 59. Owing to the eccentricity of the control cam and the fact that the control cam 55, which is arranged on the side 61 of the hook 58 facing towards the hook pivot axis 60 has a clearance 63 from the hook pivot axis 60 that increases continuously in the direction of the free end 62 of the hook 58, a clamping force that increases with increased pivoting of the hook 58 is achieved between the respective hook 58 and the respective pin 59. This provides for secure locking and more reliable sealing of the separation point 23. The spring characteristic curves of the springs 70 are preferably selected so that the restoring forces produced by the springs 70 are greater than the friction or clamping forces acting between the hook 58 and the pin 59 in the locking position. At this point, the driver's cab 37 is in its drive position 47. When the driver's cab 37 is pivoted from its drive position 47 into a tilted position 48 and the actuating fixture 64 consequently pivots now in a direction opposed to the arrow 44, the hooks 58 automatically pivot away from the pins 59. This permit opening of the separation point 63 so as to allow the bell 71 of the corrugated hose 43 firmly connected to the air inlet line 52 to be lifted off from the connecting duct 21 of the air filter 28.

According to an alternative embodiment of the invention which relates to a device 20 for mechanically closing the separation point 23 of the intake air duct 46 for an internal combustion engine of a vehicle 38 comprising a vehicle chassis 45 and the driver's cab 37 that can be pivoted in relation to the chassis about a driver's cab pivot axis 39, the separation point 23 is mechanically lockable by means of a locking mechanism 50. The locking mechanism is actuated by the pivoting of the driver's cab 37 about the driver's cab pivot axis 39 (arrow 44) into its drive position 47. The locking mechanism 50 comprises a first locking element 53 assigned to the driver's cab 37 and a second locking element 51 assigned to the air filter 28. At least one locking element 51 comprises a control cam 55, which can be displaced in bearing contact along the other locking element 53 by pivoting of the driver's cab 37 about the driver's cab pivot axis 39 into its drive position 47. In this position, the air inlet duct 52 is firmly clamped to a connecting duct 21 of the air filter 28, thereby closing the separation point 23.

What is claimed is:

1. A device (20) for mechanically locking a separation point (23) of an intake air duct (46) of an internal combustion engine of a motor vehicle (38) comprising a vehicle chassis (45) and a driver's cab (37) supported on the chassis (45) so as to be pivotable about a driver's cab pivot axis (39), an air inlet duct (52), fixed to the driver's cab (37) and supported thereby, and an air filter (28) with a connecting duct (21), which is detachably connectable to said air inlet duct (52) and is fixed to the vehicle chassis (45) and supported thereby, the device being closed when the driver's cab (37) is in a drive position (47) and opened at a separation point (23) when the driver's cab (37) together with the air inlet duct (52) is in a tilted position (48) pivoted about the driver's cab pivot axis (39) mechanically lockable by means of a locking mechanism (50) for interlocking the air inlet duct (52) and the connecting duct (21) upon pivoting of the driver's cab (37) about the driver's cab pivot axis (39) into its drive position (47), the locking mechanism (50) comprising a first locking element (51) and a second locking element (53), of which one locking element (53) is fixed to the air inlet line (52), so as to be pivotable together with the driver's cab (37) about the driver's cab pivot axis (39), and another locking element (51) is connected to the vehicle chassis (45), and comprises a control cam (55), moved into bearing contact with the other locking element (53) by pivoting of the driver's cab (37) about the driver's cab pivot axis (39) into its drive position (47), whereby the air inlet duct (52) is firmly locked with the connecting duct (21) and the separation point (23) is securely closed.

2. The device as claimed in claim 1, wherein the control cam (55) is configured so as to have a smooth, continuous line (56).

3. The device as claimed in claim 1, wherein the other locking element (51) is pivotable about a locking element pivot axis (57) associated with the connecting duct (21).

4. The device as claimed in claim 3, wherein the locking element (53) carried by the air inlet duct (52) is rigidly connected to the air inlet duct (52) and the locking element (51) assigned to the vehicle chassis (45) is pivotable about the locking element pivot axis (57).

5. The device as claimed in claim 4, wherein the locking element (51) assigned to the vehicle chassis (45) comprises a control cam (55).

6. The device as claimed in claim 5, wherein the locking element (51) assigned to the vehicle chassis (45) is in the form of a hook (58) comprising the control cam (55).

7. The device as claimed in claim 6, wherein the locking element (53) fixed to the air inlet duct (52) is in the form of a pin (59) and the hook (58), pivoting about its pivot axis (60), engages the pin (59) for the purpose of interlocking the air inlet duct (52) and the connecting duct (21) at the separation point (23).

8. The device as claimed in claim 7, wherein the control cam (55) formed on the side (61) of the hook (58) facing towards the hook pivot axis (60) has a surface providing for a clearance (63) from the hook pivot axis (60) which increases in the direction of its free end (62).

9. The device as claimed in claim 1, wherein at least two locking elements (53) are fixed to the air inlet duct (52), each of which elements can be brought into operative connection with a locking element (51) assigned to the vehicle chassis (45), in order to bring about the interlocking of the connecting duct (21) and the air inlet duct (52).

10. The device as claimed in claim 9, wherein the locking elements (51; 53) are arranged diametrically opposite one another.

11. The device as claimed in claim 1, including a mechanical actuating fixture (64) fixed to the driver's cab (37) and carried thereby for actuating the one locking elements (51) so as to be displaced relative to another locking element (53) in order to bring about a locking of the connecting duct (21) and the air inlet duct (52) at the separation point (23).

12. The device as claimed in claim 11, wherein the locking element (51) which is pivotable about a locking element pivot axis (57) is a lever (65) having first and second lever arms (66, 67) extending from the locking element pivot axis (57), the first lever arm (66) being susceptible to a force (68), which is exerted by the actuating fixture (64) when the driver's cab (37) is pivoted into its drive position (47) and which causes the lever (65) to pivot about the locking element pivot axis (57), so that the second other lever arm (67) comes into operative contact with the other locking element (53), in order to bring about the interlocking of the connecting duct (21) and the air inlet duct (52).

13. The device as claimed in claim 11, wherein the actuating fixture (64) is a rigid deflector plate fixed to the driver's cab (37).

14. The device as claimed in claim 12, wherein a rotatable body (69) is provided on one of the actuating fixture (64) and the locking mechanism (50) for transferring movement of the actuating fixture (64) to the locking mechanism (50) for moving the locking element (53) when the driver's cab (37) is pivoted into its drive position (47).

15. The device as claimed in claim 14, including a spring (70) for biasing the locking elements (53, 51) assigned to one of the air inlet line (52) and the vehicle chassis (45) into its locking position, in which the separation point (23) is closed and for unlocking the locking elements (51, 53), when the driver's cab (37) is pivoted from its drive position (47) into a tilted position (48) so that the separation point (23) can be opened and the air inlet duct (52) can be pivoted away from the connecting duct (21).
